(19) United States
(12) Patent Application Publication
(10) Pub. No.: US 2006/0025623 A1
(43) Pub. Date: Feb. 2, 2006

(54) Process for preparing alkylboronic esters

(75) Inventors: Ulrich Griesbach, Mannheim (DE); Oliver Elsner, Gottingen (DE)

Correspondence Address: CONNOLLY BOVE LODGE & HUTZ LLP, SUITE 800, 1990 M STREET NW, WASHINGTON, DC, 20036-3425, US

(73) Assignee: BASF AKTIENGESELLSCHAFT, Ludwigshafen (DE)

(21) Appl. No.: 11/188,717

(22) Filed: Jul. 26, 2005

(30) Foreign Application Priority Data
Jul. 29, 2004 (DE) 102004036853.8

(51) Int. Cl. C07F 5/04

(52) U.S. Cl. 558/286

(57) ABSTRACT

Process for preparing an alkylboronic ester (alkylboronic ester I), which comprises reductively coupling an alkyl chloride, bromide or iodide (alkyl halide compound II) with a boric ester or a boronic ester (bor(on)ic ester III) or a 1,1,2,2-tetraalkoxydiborane (tetraalkoxydiborane IV) by electrochemical means.

The present invention relates to an electrochemical process for preparing alkylboronic esters.

Alkylboronic esters are usually obtained by hydroboration of the corresponding olefins. The preparation of alkylboronic esters by an electrochemical route is hitherto unknown.

The electrochemical preparation of arylboronic esters by coupling aryl halides with pinacolborane in a reductive coupling at sacrificial anodes is known from a) C. Laza, E. Duñach, C. R. Chimie 2003, 6, 185-187, and b) C. Laza, E. Duñach, Adv. Synth. Catal. 2003, 345, 580-583]. As boron electrophiles, it is also possible to use the less expensive trimethyl or isopropyl esters of boric acid [C. Laza, E. Duñach, F. Serien-Spirau, J. J. E. Moreau, L. Vellutini, New J. Chem. 2002, 26, 373-375].

Owing to the fundamental reactivity differences aryl [symbol] benzyl [symbol] alkyl, a person skilled in the art would not have expected that the electrochemical process for synthesizing arylboronic acids could also be applied to benzyl and alkyl substrates. This is because a person skilled in the art knows that the reactions in question are related to the Grignard reaction. Such a person will know that a Grignard reagent prepared, for example, from a benzyl halide will mostly react with unreacted benzyl halide in a Wurtz coupling to form the dimer (cf. H. G. O. Becker et al., Organikum—Organisch-chemisches Grundpraktum, 12th revised and expanded edition, Wiley-VCH, Weinheim 2001 (page 559)). On the other hand, Grignard compounds obtained from haloaromatics do not dimerize. Dimerization as a secondary reaction by alkylation of the Grignard species can likewise occur in the corresponding reaction of alkyl halides.

It was an object of the invention to provide an electrochemical process for preparing alkylboronic esters economically and, in particular, in high product yields and with high selectivity.

We have accordingly found a process for preparing an alkylboronic ester (alkylboronic ester I), which comprises reductively coupling an alkyl chloride, bromide or iodide (alkyl halide compound II) with a boric ester or a boronic ester (bor(on)ic ester III) or a 1,1,2,2-tetraalkoxydiborane (tetraalkoxydiborane IV) by electrochemical means.

For the purposes of the present invention, alkylboronic esters are compounds in which an alkyl group is bound directly to the boron atom. The alkyl group has an sp³-hybridized carbon atom bound directly to the boron atom. In this context, the term alkyl encompasses cycloalkyl groups, and it is also possible for the alkyl group to be substituted (with possible substituents including aromatic radicals).

In general, the alkylboronic ester I prepared is a compound of the general formula I 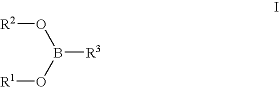
where R¹ and R² are each C₁-C₂₀-alkyl, C₃-C₁₂-Cycloalkyl, C₄-C₂₀-cycloalkylalkyl or C₄-C₁₀-aryl, or R¹ and R² together form a C₁-C₂₀-alkanediyl, C₃-C₁₂-cycloalkanediyl or C₄-C₂₀-cycloalkylalkanediyl group and R³ is a radical of the general formula A 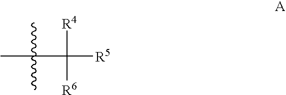
where R⁴, R⁵ and R⁶ are each hydrogen, C₁-C₂₀-alkyl, C₃-C₁₂-cycloalkyl, C₄-C₂₀-cycloalkylalkyl, C₄-C₁₀-aryl, C₅-C₂₀-arylalkyl or C₂-C₂₀-alkenyl or R⁴ and R⁵ together form a C₁-C₂₀-alkanediyl, C₃-C₁₂-Cycloalkanediyl or C₄-C₂₀-cycloalkylalkanediyl group and the abovementioned radicals may be substituted by fluorine or an amide, nitrile, C₁-C₂₀-alkylamide or di-(C₁-C₂₀-alkyl)amide group.

For this purpose, an alkyl halide compound II of the general formula II 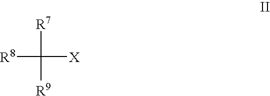
where R⁷ has the same meaning as R⁴, R⁸ has the same meaning as R⁵ and R⁹ has the same meaning as R⁶ in the general formula A and X is Cl, Br or I, and
a bor(on)ic ester III of the general formula III, 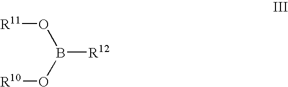
   where R¹⁰ has the same meaning as R¹ and R¹¹ has the same meaning as R² in the general formula I and
R¹² is hydrogen, C₁-C₂₀-alkoxy or C₄-C₂₀-aryloxy,
or a tetraalkoxydiborane IV of the general formula IV, 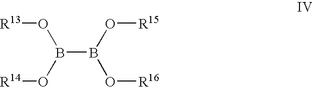
   where R¹³ has the same meaning as R¹, R¹⁴ has the same meaning as R², R¹⁵ has the same meaning as R¹ and R¹⁶ has the same meaning as R² in the general formula I,
are used as starting materials.

Particular preference is given to preparing an alkylboronic ester I in which R³ is a radical of the formula A
a1) in which R⁴ and R⁵ together form a C₅- or C₆-cycloalkanediyl group and R⁶ is hydrogen or
b1) in which R⁴ and R⁵ are each hydrogen and R⁶ is phenyl or a C₁-C₆-alkyl-substituted phenyl.

Accordingly, preference is given to using an alkyl halide compound II of the general formula II in which
a2) in the above case (a1), R⁷ and R⁸ together form a C₅- or C₆-cycloalkanediyl group and R⁹ is hydrogen and
b2) in the above case (b1), R⁷ and R⁸ are each hydrogen and R⁹ is phenyl or a C₁-C₆-alkyl-substituted phenyl.

Particular preference is given to preparing an alkylboronic ester I in which R¹ and R² together form a benzene-1,2-diyl or 2,3-dimethylbutane-2,3-diyl group.

Accordingly, preference is given to using
a3) a bor(on)ic ester III of the general formula III in which R¹⁰ and R¹¹ together form a benzene-1,2-diyl or 2,3-dimethylbutane-2,3-diyl group or, as an alternative,
a4) a tetraalkoxydiborane IV of the general formula IV in which
   R¹³ and R¹⁴ together form a benzene-1,2-diyl or 2,3-dimethylbutane-2,3-diyl group and
   R¹⁵ and R¹⁶ together form a benzene-1,2-diyl or 2,3-dimethylbutane-2,3-diyl group.

The alkyl halide compounds II, bor(on)ic esters III and tetraalkoxydiboranes IV are commercially available. In addition, the preparation of the bor(on)ic esters III and tetraalkoxydiboranes IV is known from the following references:

The preparation of bor(on)ic esters III, in particular pinacolborane, is described in C. E. Tucker, J. Davidson, P. Knochel, J. Org. Chem. 1992, 57, 3482-3485.

The preparation of bispinacoldiborane is described, for example, in N. R. Anastasi, K. M. Waltz, W. L. Weerakoon, J. F. Hartwig, Organometallics 2003, 22, 365-369, and the references cited therein. The documents U.S. Pat. No. 3,009,941 A1 and DE 1165005 B1 describe the synthesis of further tetraalkoxydiboranes IV.

The alkylhalide compounds II and bor(on)ic esters III or tetraalkoxydiboranes IV are generally used in at least equi molar amounts in the electrolyte. The bor(on)ic esters III or tetraalkoxydiboranes IV are preferably used in excess over the alkyl halide compounds II, particularly preferably in a ratio of from 1.1:1 to 4:1.

Customary cosolvents can be added to the electrolysis solution if appropriate. These are the inert solvents having a high oxidation potential which are generally customary in organic chemistry. Examples which may be mentioned are tetrahydrofuran, acetonitrile, dimethylformamide, dimethoxyethane, dimethyl carbonate and propylene carbonate.

Electrolyte salts present in the electrolysis solution are generally alkali metal salts or tetra(C₁-C₆-alkyl)ammonium salts, preferably tri(C₁-C₆-alkyl)methylammonium salts. Possible counterions are sulfate, hydrogensulfate, alkylsulfates, arylsulfates, halides, phosphates, carbonates, alkylphosphates, alkylcarbonates, nitrate, alkoxides, tetrafluoroborate or perchlorate. Particular preference is given to (CF₃SO₂)₂NLi.

Alternatively, ionic liquids are also suitable as electrolyte salts. Suitable ionic liquids are described in “Ionic Liquids in Synthesis”, editors Peter Wasserscheid, Tom Welton, Verlag Wiley VCH, 2003, chapter 3.6, pages 103-126.

Very particular preference is given to the combination of tetrahydrofuran as cosolvent and (CF₃SO₂)₂NLi as electrolyte salt.

The process of the invention can be carried out in all customary divided or undivided types of electrolysis cell. It is preferably carried out continuously in undivided flow-through cells.

Particularly useful cells are bipolar capillary cells or plate stack cells in which the electrodes are configured as plates and are arranged in parallel (cf. Ullmann's Encyclopedia of Industrial Chemistry, 1999 electronic release, Sixth Edition, VCH-Verlag Weinheim, Volume Electrochemistry, Chapter 3.5. Special Cell Designs and Chapter 5, Organic Electrochemistry, Subchapter 5.4.3.2 Cell Design). Graphite is preferred as electrode material.

Preference is also given to using “pencil sharpener” cells as are described in J. Chaussard et al. J. Appl. Electrochem. 19 (1989), 345-348.

The electrolysis cells are generally provided with a sacrificial anode. Discharge of the anode occurs essentially by metal atoms present in the sacrificial anode being oxidized to cations. The cathode material is therefore generally a metal having a negative standard potential. Preference is given to aluminum, zinc, calcium or preferably magnesium.

The cathode generally comprises graphite, diamond, platinum, iron, nickel or a steel selected from the group consisting of unalloyed steels and alloy steels with additions of chromium, manganese or boron as alloying constituents. The term iron encompasses not only elemental iron but also the known types of iron containing varying amounts of Si, Mn, S, P as alloying constituents and also additions of Al, Cr, Mn, Mo, Ni, Ta, Ti, Vn, Si, Co and other customary alloying constituents. Particular preference is given to V₂A or V₄A stainless steel.

The shape of anode and cathode is not subject to any restrictions and can comprise, for example, meshes, plates, cylinders, cones or tubes.

When the process is carried out continuously, the feed rate of the starting materials is generally selected so that the weight ratio of the sum of alkyl halides II, bor(on)ic esters III and tetraalkoxydiborane IV to the alkylboronic esters I in the electrolyte is from 10:1 to 0.05:1.

The current densities at which the process is carried out are generally from 1 to 1000 mA/cm², preferably from 1 to 100 mA/cm². The process is generally carried out at atmospheric pressure. Higher pressures are preferably employed when the process is to be carried out at relatively high temperatures, so that boiling of the starting compounds or of the solvent is avoided.

After the reaction is complete, the electrolyte solution is worked up by generally customary separation methods. For this purpose, the electrolysis solution is in general firstly distilled and the individual compounds are obtained separately in the form of various fractions. Further purification can be carried out by, for example, crystallization, extraction, distillation or chromatography.

### EXPERIMENTAL PART

### Example 1

### Synthesis of 2-(4-isopropylbenzyl)-4,4,5,5-tetramethyl[1.3.2]dioxaborolane 4 from isopropylbenzyl bromide 1

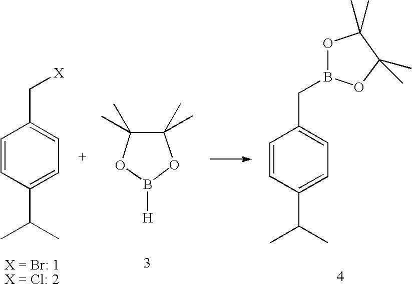

4-Isopropylbenzyl bromide 1 (3.0 mmol, 0.64 g, 0.51 ml), (CF₃SO₂)₂NLi (4.2 mmol, 1.21 g) and pinacolborane 3 (9.0 mmol, 1.15 g, 1.31 ml) were dissolved in THF (58 ml). The electrolysis was started using a steel cathode and a magnesium anode (effective area: 10 cm² in each case) and a start-up voltage of 70 V for 30 seconds. Electrolysis was then carried out at a constant current of 0.06 A (i=6 mA/cm²). At the anode, 96.8 mg (3.98 mmol, 1.33 eq.) of magnesium went into solution.

Analysis of the crude product by gas chromatography indicated a yield of 81% of 4.

### Example 2

### Synthesis of 2-(4-isopropylbenzyl)-4,4,5,5-tetramethyl[1.3.2]dioxaborolane 4 from isopropylbenzyl chloride 2

4-Isopropylbenzyl chloride 2 (3.0 mmol, 0.51 g, 0.49 ml), (CF₃SO₂)₂NLi (4.2 mmol, 1.2 g) and pinacolborane 3 (9.0 mmol, 1.15 g, 1.3 ml) were dissolved in THF (58 ml). The electrolysis was started using a steel cathode and a magnesium anode (effective area: 10 cm² in each case) and a start-up voltage of 65 V for 30 seconds. Electrolysis was then carried out at a constant current of 0.06 A (i=6 mA/cm²). At the anode, 108 mg (4.44 mmol, 1.48 eq.) of magnesium went into solution. After the reaction, the solvent was removed under reduced pressure and the residue was taken up in 50 ml of 1N—HCl. The mixture was extracted four times with 50 ml of CH₂Cl₂, the combined organic phases were washed twice with 50 ml of 0.05 M NaOH and 100 ml of H₂O, dried over Na₂SO₄ and the solvent was removed under reduced pressure. This gave 0.75 g (96%) of 4 as a colorless liquid which, according to NMR analysis, has a purity of about 95%.

### Example 3

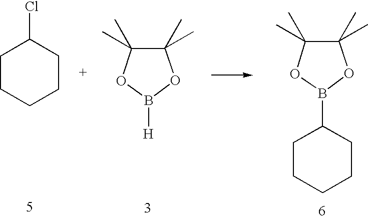

### Synthesis of 2-cyclohexyl-4,4,5,5-tetramethyl[1.3.2]dioxaborolane 6

Chlorocyclohexane 5 (3.0 mmol, 0.36 g), (CF₃SO₂)₂NLi (4.2 mmol, 1.21 g) and pinacolborane 3 (9.0 mmol, 1.15 g, 1.31 ml) were dissolved in THF (58 ml). The electrolysis was started using a steel cathode and a magnesium anode (effective area: cm² in each case) and a start-up voltage of 60 V for 20 seconds. The electrolysis was stopped after an amount of charge of 4.5 F/mol had been passed through the cell. The solvent was removed under reduced pressure, the residue was taken up in 50 ml of 1N-HCl and extracted four times with 50 ml of CH₂Cl₂. The combined organic phases were washed twice with 50 ml 0.05 of NNaOH and 100 ml of H₂O, dried over Na₂SO₄ and the solvent was removed under reduced pressure. This gave 0.27 g (1.30 mmol, 44%) of 6 as a colorless liquid which, according to NMR analysis, has a purity of 80-90%. At the anode, 136 mg (5.58 mmol, 1.86 eq.) of magnesium went into solution.

1. A process for preparing an alkylboronic ester (alkylboronic ester I), which comprises reductively coupling an alkyl chloride, bromide or iodide (alkyl halide compound II) with a boric ester or a boronic ester (bor(on)ic ester III) or a 1,1,2,2-tetraalkoxydiborane (tetraalkoxydiborane IV) by electrochemical means.

2. The process according to claim 1, wherein
I. the alkylboronic ester I is a compound of the general formula I 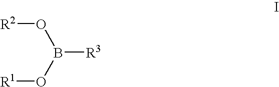
where R¹ and R² are each C—C₂₋₀-alkyl, C₃-C₁₂-Cycloalkyl, C₄-C₂₀-Cycloalkylalkyl or C₄-C₁₀-aryl, or R¹ and R² together form a C₁-C₂₀-alkanediyl, C₃-C₁₂-cycloalkanediyl or C₄-C₂₀-Cycloalkylalkanediyl group and
R³ is a radical of the general formula A 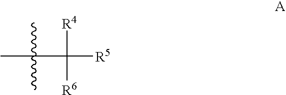
where R⁴, R⁵ and R⁶ are each hydrogen, C₁-C₂₀-alkyl, C₃-C₁₂-cycloalkyl, C₄-C₂₀-cycloalkylalkyl, C₄-C₁₀-aryl, C₅-C₂₀-arylalkyl or C₂-C₂₀-alkenyl or R⁴ and R⁵ together form a C₁-C₂₀-alkanediyl, C₃-C₁₂-cycloalkanediyl or C₄-C₂₀-cycloalkylalkanediyl group and the abovementioned radicals may be substituted by fluorine or a nitro, amide, nitrile, C₁-C₂₀-alkylamide or di-(C₁-C₂₀-alkyl)amide group,
II. the alkylhalide compound II is a compound of the general formula II 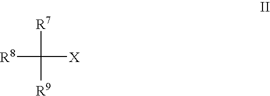
where R⁷ has the same meaning as R⁴, R⁸ has the same meaning as R⁵ and R⁹ has the same meaning as R⁶ in the general formula A and X is Cl, Br or I,
III. the bor(on)ic ester III is a compound of the general formula III, 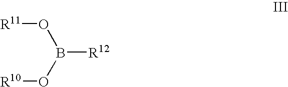
where R¹⁰ has the same meaning as R¹ and R¹¹ has the same meaning as R² in the general formula I and
R¹² is hydrogen or C₁-C₂₀-alkoxy or C₄-C₂₀-aryloxy, and
IV. tetraalkoxydiborane IV is a compound of the general formula IV, 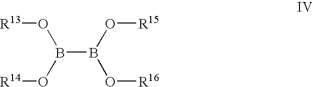
where R¹³ has the same meaning as R¹, R¹⁴ has the same meaning as R², R¹⁵ has the same meaning as R¹ and R¹⁶ has the same meaning as R² in the general formula I.

3. The process according to claim 1, wherein the alkyl halide compound II used is a compound in which R⁷ and R⁸ together form a C₅- or C₆-alkanediyl group and R⁹ is hydrogen.

4. The process according to claim 1, wherein the alkyl halide compound II used is a compound in which R⁷ and R⁸ are each hydrogen and R⁹ is phenyl or a C₁-C₆-alkyl-substituted phenyl.

5. The process according to claim 1 wherein the bor(on)ic ester III used is a compound in which R¹⁰ and R¹¹ together form a benzene-1,2-diyl or 2,3-dimethylbutane-2,3-diyl group.

6. The process according to claim 1, wherein the tetraalkoxydiborane IV used is a compound in which
R¹³ and R¹⁴ together form a benzene-1,2-diyl or 2,3-dimethylbutane-2,3-diyl group and
R¹⁵ and R¹⁶ together form a benzene-1,2-diyl or 2,3-dimethylbutane-2,3-diyl group.

7. The process according to any of the preceding claims claim 1, carried out in an undivided cell which is provided with a sacrificial anode and in which discharge of the anode occurs essentially by metal atoms present in the sacrificial anode being oxidized to cations.

8. The process according to claim 7, wherein the sacrificial anode comprises a metal having a negative standard potential.

9. The process according to claim 1, carried out in a cell which is provided with a cathode comprising graphite, diamond, platinum, iron, nickel or a steel selected from the group consisting of unalloyed steels and alloy steels with additions of chromium, manganese or boron as alloying constituents of the alloy steels.

10. The process according to claim 1 wherein an electrolyte comprising tetrahydrofuran as cosolvent and (CF₃SO₂)₂NLi as electrolyte salt is used.

11. The process according to claim 2, wherein the alkyl halide compound II used is a compound in which R⁷ and R⁸ together form a C₅- or C₆-alkanediyl group and R⁹ is hydrogen.

12. The process according to claim 2, wherein the alkyl halide compound II used is a compound in which R⁷ and R⁸ are each hydrogen and R⁹ is phenyl or a C₁-C₆-alkyl-substituted phenyl.

13. The process according to claim 3, wherein the alkyl halide compound II used is a compound in which R⁷ and R⁸ are each hydrogen and R⁹ is phenyl or a C₁-C₆-alkyl-substituted phenyl.

14. The process according to claim 2, wherein the bor(on)ic ester III used is a compound in which R¹⁰ and R¹¹ together form a benzene-1,2-diyl or 2,3-dimethylbutane-2,3-diyl group.

15. The process according claim 3, wherein the bor(on)ic ester III used is a compound in which R¹⁰ and R¹¹ together form a benzene-1,2-diyl or 2,3-dimethylbutane-2,3-diyl group.

16. The process according to claim 4, wherein the bor(on)ic ester III used is a compound in which R¹⁰ and R¹¹ together form a benzene-1,2-diyl or 2,3-dimethylbutane-2,3-diyl group.

17. The process according to claim 2, wherein the tetraalkoxydiborane IV used is a compound in which
R¹³ and R¹⁴ together form a benzene-1,2-diyl or 2,3-dimethylbutane-2,3-diyl group and
R¹⁵ and R¹⁶ together form a benzene-1,2-diyl or 2,3-dimethylbutane-2,3-diyl group.

18. The process according to claim 3, wherein the tetraalkoxydiborane IV used is a compound in which
R¹³ and R¹⁴ together form a benzene-1,2-diyl or 2,3-dimethylbutane-2,3-diyl group and
R¹⁵ and R¹⁶ together form a benzene-1,2-diyl or 2,3-dimethylbutane-2,3-diyl group.

19. The process according to claim 4, wherein the tetraalkoxydiborane IV used is a compound in which
R¹³ and R¹⁴ together form a benzene-1,2-diyl or 2,3-dimethylbutane-2,3-diyl group and
R¹⁵ and R¹⁶ together form a benzene-1,2-diyl or 2,3-dimethylbutane-2,3-diyl group.

20. The process according to claim 5, wherein the tetraalkoxydiborane IV used is a compound in which
R¹³ and R¹⁴ together form a benzene-1,2-diyl or 2,3-dimethylbutane-2,3-diyl group and
R¹⁵ and R¹⁶ together form a benzene-1,2-diyl or 2,3-dimethylbutane-2,3-diyl group.
